(19) United States
(12) Patent Application Publication
(10) Pub. No.: US 2003/0157304 A1
(43) Pub. Date: Aug. 21, 2003

(54) Printed textile

(76) Inventors: Shulong Li, Spartanburg, SC (US); William E. Rice, Fountain Inn, SC (US); Anthony S. Brandon, Moore, SC (US)

Correspondence Address: Jeffery E. Bacon, Legal Department, M-495, PO Box 1926, Spartanburg, SC, 29304, US

(21) Appl. No.: 10/268,537

(22) Filed: Oct. 10, 2002

Related U.S. Application Data
(63) Continuation-in-part of application No. 09/943,920, filed on Aug. 31, 2001.

(51) Int. Cl. B32B 3/00

(52) U.S. Cl. 428/195

(57) ABSTRACT

A textile substrate is treated with a composition having a dye fixing agent and an ink receiving agent, for the subsequent printing with an ink jet printer. The dye fixing agent includes a reactive amino compound which chemically bonds with the textile substrate. A resin binder can also be used where the dye fixing agent does not provide an adequate bond to the textile substrate, a resin binder can be used to bond with the textile substrate and the dye fixing agent can bond with the resin binder. The ink receiving agent comprises inorganic particles such as bohemite alumina or silica gel.

### CROSS-REFERENCE TO RELATED APPLICATION

This Application is a continuation-in-part of co-pending, prior application Ser. No. 09/943,920 having a filing date of Aug. 31, 2001 the contents of which are incorporated by reference herein in their entirety.

### BACKGROUND

The present invention generally relates to the printing of textiles.

Due to the many various types of textile substrates that printing is performed on, and the many various types of printing inks, is often difficult to obtain consistency in the quality of the print between printed textiles. These complications are magnified by the difficulty of obtaining a quick drying, sharp focused print on textile materials in general. Additionally, pigment based inks require additional binders, and most dyes require an additional dye fixing process when printing on a textile.

Therefore, there is a need for materials that allow the printing on various different types of textiles with various different types of printing inks thereon, enhance the fast pickup of the ink on the textile and help in obtaining sharp well defined patterns, and assist in the reduction of the need for special binders or fixing processes for printing on textiles.

### DETAILED DESCRIPTION

The present invention is directed to the treatment of a textile substrate for the subsequent reception of a printing ink, such as ink from an ink jet printer. In one embodiment, the treatment of the present invention includes the placement of a treatment of a dye fixing/receiving composition on the surface of the textile substrate which is to receive the printed ink, prior to placement of the printing ink on the textile substrate. The dye fixing/receiving composition generally includes a dye fixing agent and an ink receiving agent. In one embodiment, the dye fixing/receiving compound can include a compatible resin binder. Additional additives can be used with the dye fixing/receiving composition, such as whitening agents, antimicrobial agents, light stabilizers/UV absorbers, and lubricants. The textile with the dye fixing/receiving agent thereon can also be subjected to a mechanical treatment to improve the flexibility and surface touch of the treated textile. In another embodiment, the treatment of the present invention includes the placement of a UV absorber on the surface of the textile substrate which is to receive the printed ink, prior to placement of the printing ink on the textile substrate.

The textile substrate contributes to whiteness, texture, and physical porous structure for holding the ink. The textile substrate can be a knit, woven, nonwoven, or similar type textile. In one embodiment, the textile substrate is a tight woven fabric. It has been found that textile substrates formed of dull white opaque textured or spun yarns provide a good substrate for the present invention. For example, tightly woven fabrics from cotton staple yarns provide opacity and absorbency that assists in the functions of the treatment of the textile substrate. The material of the textile substrate can be synthetic, natural, or regenerated. In most cases, it is the treatment that receives a majority of the dyes in the ink. It has been found that the present invention with a bright white substrate provides better brightness and contrast for the resulting image on the textile. The surface touch of the textile substrate, before and after treatment and printing, can be greatly improved by surface sanding, especially by the use of fine grade sanding media prior to treatment of the substrate. Sanding with fine grid sanding media, such as fine diamond, gives the fabric surface fine short fibers, which is responsible for smooth and soft touch. In one embodiment, the hairiness of the textile substrate was measured with average fiber heights of about 0.15 millimeters or greater, and an average level of about 0.3-0.8 millimeters was preferred. In these hairiness levels, the present inventors have discovered that the inkjet printing process or print quality are not effected.

The dye fixing/receiving composition of the present invention includes a dye fixing agent and an ink receiving agent. In one embodiment, the fixing agent has a molecular weight of at least about 1000. The fixing agent of the present invention comprises reactive amino compounds of a highly cationic nature. A preferred reactive amino compound is a compounds having a high positive charge density (i.e., at least two (2) milliequivalents per gram). Reactive amino compounds that can be used in the present invention include compounds containing at least one primary, secondary, tertiary, or quaternary amino moiety. Additionally, the reactive amino compounds can contain a reactive group that is capable of reacting with the textile substrate or resin binder to form a bond thereto. Examples of a reactive group include epoxide, isocyanate, vinylsulphone, and halo-triazine. In particular, it was found that epichlorolhydrin polyamine condensation polymer worked well as the amino compound in the present invention.

Ink receiving agents of the present invention are inorganic particles that receive the ink through adsorbancy or absorbancy. In one embodiment, the particle size of the ink receiving agent is equal to, or less than, about 10 microns. In another embodiment, the particle size of the ink receiving agent is equal to, or less than, about 3 microns. In yet another embodiment, the particle size of the ink receiving agent is equal to, or less than, about 1 micron. Examples of ink receiving agents of the present invention include silica, silicate, calcium carbonate, aluminum oxide, aluminum hydroxide, and titanium dioxide.

In particular, it has been found that Bohemite alumina and silica gel work well as the ink receiving agents in the present invention, especially silica gel particle that have been treated to carry a cationic charge. In the case of silica gel particles, alumina surface coating and cationic silane surface modification are preferred. It is believed that the microporous nature of the bohemite alumia and silica gel allow further physical entrapment of a dye/pigment, such as an anionic dye/pigment, to afford improved wash fastness. In one embodiment, the inorganic particles have a porousity with a pore diameter from about 10 nm to about 200 nm.

In most formulations, the cationic charge from cationic reactive amino compounds is much greater than the cationic charge present on the inorganic particles. Therefore the mere presence of relative minor cationic charge on the inorganic particle would not significantly improve the dye/substrate interaction through cationic-anionic charge interaction. It is combination of highly charged reactive amino compound and the microporous inorganic particles that further improves the washfastness of a printed article.

In one embodiment, the fixing agent typically will comprise from about 0.2% to about 20% by weight of the treated textile substrate. In one, embodiment, the ink receiving agent typically will comprise from about 0.2% to about 20% by weight of the treated textile substrate. In one embodiment, the dye fixing/adsorbing composition comprises from about 1% to about 20%, by weight, of the treated textile substrate. In another embodiment, the dye fixing/adsorbing composition comprises from about 1% to about 5%, by weight, of the treated textile substrate. In another further embodiment, the dye fixing/adsorbing composition comprises from about 5% to about 10%, by weight, of the treated textile substrate. Prior to placement on the textile substrate, the dye fixing/receiving composition is preferably in the form of a stable aqueous solution or dispersion.

In the embodiment using a resin binder, the resin binder must be a binder that will have good a bond with the fiber of the textile substrate. The resin binder can be a thermoplastic or thermosetting polymeric binder. It is preferable that the resin binder has a glass transition temperature of below about 40° C. It is also preferred that the binder be durable when subjected to washing. Examples of resin binders include non-anionic or cationic latices, such as ethylenevinylacetate, acrylic, urethane polymer, polyamide, polyester, and polyvinyl chloride. In one embodiment, the resin binder comprises up to about 10% of the weight of the treated substrate.

Whitening agents can include white pigments and optical brighteners. White pigments provide an improved white background for the inks and dyes placed on the textile substrate, thereby increasing the contrast of the image on the textile substrate. Examples of white pigments would include zinc oxide and titanium oxide, and calcium carbonate. Optical brighteners having photo-luminescent properties brighten the background of the textile substrate to provide a greater contrast with the inks and dyes placed on the textile substrate. Examples of optical brighteners could include stylbene based materials such as Leucophor from Clariant Corporation.

An antimicrobial agent inhibits the growth of microorganisms, such as bacteria, fungi, or the like, which can cause discoloring of an image on the textile substrate and/or degradation of the textile substrate itself. The antimicrobial agent can be an additive which is compatible with the cationic fixing agents, and is durable to weathering. Examples of suitable antimicrobial would include polyguanidine, silver zirconium phosphate, and quaternary aminosilane.

Light stabilizers are materials that contribute to stabilizing the colorants in the printed ink and textile substrate. Examples of light stabilizers could include hindered amines and hindered phenol, such as Cyasorb 3346 by Cytec Industries and Irganox by Ciba Specialty Chemicals.

UV absorbers are materials that strongly absorb harmful UV radiation, thereby reducing the exposure of the colorants in the printed ink from the harmful UV radiation. In one embodiment, the UV absorber comprises from about 0.1% to about 10% of the weight of the treated textile substrate. Traditionally, it was believed that the UV absorbers needed to be applied with the ink or cover the ink as a post treatment to provide protection. However, a surprising discovery of the present invention is that placement of the UV absorber on the textile before printing of the ink, provides an unexpected result of improved light fastness. Examples of UV absorbers can includes benzyltriazoles, hydroxylphonones, and Dihydroxygybenzylphenone, such as Tinuvin 1130 by Ciba Specialty Chemicals.

It has been discovered by the present inventors that by incorporation of small amount of lubricating agent, the friction force of a needle going through the treated textile in a sewing process can be greatly reduced. Lubricating agents are materials that significantly reduce surface friction. Examples of suitable lubricating agents would include olefin waxes, polysiloxanes, fatty acids and the derivatives thereof, and the like. The reduction of needle friction with a lubricant can be accomplished with out any adverse effect on the printing quality, or print durability. In fact, the fabric handle or surface touch is not usually affected by the lubricant, while needling resistance is greatly improved.

The treatment can be applied to the textile substrate by dipping, coating, spraying, powder coating, hot melt coating, and other similar methods. The treatment can be applied to the textile substrate in a single application, or multiple applications. Additionally, the various components of the treatment can be applied together, in particular groupings, or individually. In one embodiment, the treatment is applied to the substrate textile by impregnation or coating, which is then followed by a drying process.

In the embodiment of the treatment having reactive amino compounds, the drying process is typically conducted under an elevated temperature to activate the reactive amino compounds of the dye fixing agent for bonding with the textile substrate and/or the resin binder. An elevated temperature for the drying process is a temperature that accelerates the evaporation of solvents in the treatment and the reaction of the reactive amino compound with the substrate and/or the binder. Typically, an elevated temperature for the drying process would be from about 100° C. to about 150° C.

The present inventors have discovered that a water fast and wash durable print can be obtained with a high and durable cationic chagred density on the fabric. Cationic charge density is measured by the moles of cationic charges bound to the textile substrate per unit area. It is believed that higher charge densities provide more anchoring sites for fixing anionic colorants to the fabric. The present inventors have found that a charge density of at least about 2 meq/m² provides a satisfactory charge density for the present invention.

Fabrics treated with charged materials and inorganic particles can be stiff and harsh to touch, which is undesirable. The present inventors have found that the flexibility of the treated textile can be greatly improved by a mechanical treatment, such as intense vibration, stretching, and localized distortion. Surprisingly, no significant adverse effect on printing quality and print durability is observed on textiles that have been treated and then subjected to such mechanical treatment.

The designs or images are placed on the treated surface of the substrate. In one embodiment, the design or image is placed on the treated substrate by an ink jet printer, such as the type for home, office, or commercial uses. The printing ink can contain anionic dye and/or anionic pigments. It has been found that the present invention works well when the printing ink contains an acid dye, a reactive dye, a direct dye, or similar anionic colorants. It has also been found that by ironing the print on the textile substrate with or without steam, or by drying the printed article in a home dryer, the color fastness of the printed article may be improved.

It is believed that the dye fixing agent interacts with the ionic dyes from an ink jet printer ink in a charge type attraction, and that the dye fixing agent of the present invention typically will react with the fiber of the textile substrate to form a chemical bond with the textile substrate. In an embodiment where a resin binder is used, it is believed that the dye fixing agent will chemically bond with the resin binder, which bonds with the textile substrate. It is also believed that the ink receiving agent provides surface area for the ink from the ink jet printer to interact with the dye fixing agent, thereby facilitating the effects of the dye fixing agent. The interaction of the dye fixing agent and the ink receiving agent provide a surprising result in an improved color yield and image wash durability. The use of the dye fixing/receiving composition as the treatment in the present invention, provides a wash durable and crocking resistant print with little, or no, subsequent fixing procedures or chemical treatment.

The present invention allows well defined pixels to form and facilitates the drying process of the print. The present invention improves the quality of the printed image while preserving the flexible hand of the underlying textile substrate. The present invention also allows the use of various different types in inks various different types of substrate textiles.

The print exhibits good crocking resistance and water fastness within a few minutes after printing. The article with the image can also withstand repeated laundry cycles with little color fade. It has been discovered that the present invention works well when the pH of the laundry detergent is in the range of from about 4 to about 8.

The present inventors have also discovered that certain anionic dyes used in combination the treated substrate give excellent water and washfastness to a printed article. Such anionic dyes are those containing at least 2 net anionic charge on the chromophore moiety on each molecule when fully disassociated in a polar solvent. Preferably, at least one of the anionic charges are provided by a moiety from the carboxylic acid group.

The present inventors have also discovered that textile substrates treated with the present invention can provide a printed textile with excellent color brightness and print resolution when an aqueous pigment ink is placed on the treated textile substrate by an ink jet printing process. Pigment inks are commonly used to provide an image on a textile due to the superior lightfastness and environmental stability of such inks. However, when the image is placed on the textile with an ink jet printer, the ink jet printer needs an ink with low viscosity and that does not dry up to plug the ink jet nozzles. To meet the needs of an ink jet printer, pigment ink without resin binders are becoming commonly used in ink jet printing processes. However, inks without resin binders typically have poorer rub fastness, waterfastness, and washfastness on textiles. In order to overcome these characteristics, the prior art has used post-printing lamination or coating to provide a permanency to the print.

Surprisingly, an aqueous pigment ink, with a pigment to ink ratio of about 10 to 1 or greater, by weight, of binder can be ink jet printed on a treated textile substrate of the present invention to produce a water fast and weatherable printed image on the treated textile without the use of post-printing lamination or coating. Furthermore, the present inventors have found that the pigment ink with about 10%, by weight, or less of binder can be printed onto the textile substrate with a treatment of a quanternary amino compound, with or without the inorganic particles, and provide a durable print. The quanternary amino compound can be secured to the textile substrate by a chemical bond, or any other appropriate method. It is believed that the treatment swells when it receives the aqueous ink. It is also believed that this swelling will increase the chances of the interaction between the pigment particles of the ink and highly cationic and porous features of the treatment. As a result, a long-lasting print can be placed on a textile substrate using either a thermal or piezo ink jet printing process without post-printing lamination.

The present invention can be better understood with reference to the following examples:

### EXAMPLES 1-3

A treatment mixture containing a reactive dye fixing agent, Kymene 736 (manufactured by Hercules, Wilmington, Del.), a inorganic silica particle dispersion, Ludox CL-P (manufactured by W. R. Grace & Co., Columbia, Md.), and a ethylene vinylacetate latex binder, Airflex TL-51 (manufactured by Air Products and Chemicals, Inc., Allentown, Pa.) was made according to the following formula:

| | |
|---|---|
| Ludox CL-P | 8 parts by weight |
| Kymene 736 | 12 parts by weight |
| Airflex TL-51 | 4 parts by weight |
| Water | 76 parts by weight |

A small amount of ammoina hydroxide solution was added to adjust the pH to 11.

A woven cotton Poplin substrate (Example 1), a plain woven 50/50 polyester/cotton substrate (Example 2), and a plain woven polyester substrate with textured yarns (Example 3), were separately impregnated with the above treatment solution, passing through nip rolls to get a wet pickup of about 60%. The impregnated substrates were dried in a convection oven at 300° F. for 3 minutes.

The treated substrates were printed with solid circles and squares of 3 primary colors (red, blue, yellow) and black using Hewlett Packard DeskJet 932C ink jet printer. The images on each of the treated substrates showed very good sharpness at the edges, with excellent color holdout and no evidence of ink feathering. The printed substrates were then washed in a regular home washer using delicate cycle using Gentle Cycle Woolite neutral detergent following AATCC Standardization of Home Laundry Text Condition (Developed in 1984 by AATCC Committee RA88, and as revised in 1986, 1992, and 1995.). The substrates were then dried in a regular home dryer at low heat for 20 minutes. Very little color loss was observed after the washing. No color bleeding or migration was observed. Color value (CIE L*, a* and b* values) of each of the colors on the printed substrates after one wash and five washes was measured using an X-Rite SP78 Spectrophotometer utilizing the QA Master software for Microsoft Windows Version 1.71 (both manufactured by X-Rite Inc., Grandville, Mich.). E versus the color printed on a piece of white paper was used to measure the degree of color loss. Wet crocking (AATCC test method 8-1996), and waterfastness (AATCC test method 107-1997) were also measured on each primary color on the substrates after one wash. The test results are summarized in Table 1 and Table 2.

TABLE 1
Test Values After One Wash

| | | Black | Yellow | Red | Blue |
|---|---|---|---|---|---|
| Example 1 | ΔE vs. paper | 2.05 | 18.41 | 7.20 | 8.21 |
| (Cotton) | Wet Crocking* | 1 | 4 | 4 | 3 |
| | Water Colorfastness | 5 | 5 | 5 | 5 |
| Example 2 | ΔE vs. paper | 3.35 | 26.31 | 14.17 | 9.00 |
| (50/50 | Wet Crocking* | 1 | 2.5 | 3 | 3 |
| Cotton/PET) | Water Colorfastness | 5 | 5 | 5 | 5 |
| Example 3 | ΔE vs. paper | 2.74 | 39.27 | 23.00 | 12.80 |
| (PET) | Wet Crocking* | 1.5 | 3 | 1.5 | 2.5 |
| | Water Colorfastness | 5 | 5 | 5 | 5 |

*AATCC Grey Scale for Staining

TABLE 2
Test Values After Five Washes

| | | Black | Yellow | Red | Blue |
|---|---|---|---|---|---|
| Example 1 (Cotton) | ΔE vs. paper | 0.63 | 5.67 | 5.25 | 4.96 |
| Example 2 | ΔE vs. paper | 8.62 | 11.20 | 9.73 | 9.06 |
| (50/50 Cotton/PET) | | | | | |
| Example 2 (PET) | ΔE vs. paper | 5.40 | 14.82 | 11.73 | 9.92 |

* AATCC Grey Scale for Staining

### EXAMPLES 4-6

Control examples were formed using the same substrates as in Examples 1-3 without treatment, as the corresponding Examples 4-6. The untreated substrates were printed using the same printer with the same prints as in Examples 1-3. A significant ink feathering was noticed on the control example of the polyester fabric, and a small degree of ink feathering was noticed on the control example of the 50/50 polyester cotton blend substrate. Lower color yield was observed on all the control examples compared with corresponding treated substrates in Exmaples 1-3. After one home wash as described in Examples 1-3, there was very little color remained on the fabric.

### EXAMPLE 7

Similar formula as in Examples 1-3 was used, except that Ludox CP-L was not included. The same cotton woven cotton substrate as in Example 1 was treated in the same manner as Example 1. Print quality and color fastness were measured. The color yield of Example 7 was lower and the print was not as wash fast as treated cotton substrate in Example 1.

### EXAMPLE 8

Similar formula as in Examples 1-3 was used, except that Kymene 736 was not included. The same cotton woven cotton substrate as in Example 1 was treated in the same manner as Example 1. Print quality and color fastness were measured. The color yield of Example 8 was significantly lower and dramatic color loss was observed after one wash.

### EXAMPLE 9

Similar formula as in Example 1 was used, except that 1 part of Reputex 20 (antimicrobial agent manufactured by Avecia Biocides, Wilmington, Del.) was added to 100 parts by weight of the treatment mixture in Example 1. The treated cotton substrate of Example 1, the untreated cotton substrate of Example 4, and the treated antimicrobial substrate of Example 9 were tested for antimicrobial performance. Antibacteria testing was performed using AATCC test method 100, and the results are shown in Table 3. An antifungal test using ISO 846 Test method was also conducted on these substrates and the results are shown in Table 4. The cotton substrate of Example 9 treated with the antimicrobial showed excellent antibacteria and antifungal performance. Aspergillus niger is one of the most common fungus that causes mildew staining. Chaetomium globosum is one fungus that can grow on cellulosic material and therefore can biologically degrade and destroy cotton fabric. A treatment containing Reputex 20 therefore can help prevent mildew staining and biological degradation of cotton fabric.

TABLE 3
Antibacteria Test Against Staphylococcus

| Test Sample | Log Reduction |
|---|---|
| Example 4 | 1.37 |
| (Without Treatment) | |
| Example 1 | 0.57 |
| (Treatment w/o Antimicrobial) | |
| Example 9 | 4.40 |
| (Treatment with Antimicrobial) | |

TABLE 4
Antifungal Test*

| | | Chaetomium |
|---|---|---|
| Test Sample | Aspergillus Niger | Globosum |
| Example 4 | 10/10 | 10/10 |
| (Without Treatment) | | |
| Example 1 | 10/10 | 1/10 |
| (Treatement w/o Antimicrobial) | | |
| Example 9 | 0/10 | 1/10 |
| (Treatment with Antimicrobial) | | |

*Number of drops of standard fungus solution showing growth out of 10 drops of inoculum after one week.

### EXAMPLE 10

Similar formula as in Examples 1-3 was used, except that 1 part by weight of Sunlife LPS-911 (UV absorber manufactured by Nicca USA, Fountain Inn, S.C.) was added to 100 parts by weight of the treatment mixture in Examples 1-3. A cotton substrate as described in Example 1 was treated and printed as described for Examples 1-3. Xenon lightfastness (AATCC test method 16-1998) at 20 hours exposure were tested and compared with treated cotton in Example 1 and printed paper subjected to the same exposure. The results of the testing are summarized in Table 5. Lightfastness was improved by using the treatment formula for Example 10 containing UV absorber. It is somewhat surprising as the colorants were applied on top UV absorber treatment. The present inventors believe that some of the UV absorber must have migrated towards the surface and/or the dyes in the printing ink migrate beneath the treatment.

TABLE 5
Light Fastness

| Test Sample | Black | Yellow | Red | Blue | Average |
|---|---|---|---|---|---|
| Paper | 5.0 | 4.5 | 2.5 | 1.5 | 3.4 |
| Example 1 | 5.0 | 1.0 | 1.0 | 1.5 | 2.1 |
| Example 10 | 5.0 | 4.0 | 3.5 | 2.0 | 3.6 |

### EXAMPLE 11

The following formula, in parts by weight, was used as a treatment on a woven Poplin cotton fabric:

| | |
|---|---|
| Epi-rez 6006-w-70 | 4 parts |
| (waterborne epoxy resin, by | |
| Shell Chemical Company, | |
| Houston Texas) | |
| Ancamide 500 | 4 parts |
| Ludox Cl-P | 10 parts |
| Water | 82 parts |

Epi-rez acts both as resin binder and reactive agent that couples with Ancamide (amino compound containing both primary and secondary amines) to generate a durable amine containing finish. The cotton fabric was treated using this formula in the same manner as described in Example 1, and printed and test in the same manner.

### EXAMPLE 12

A treatment mixture containing a reactive dye fixing agent, Kymene 736 (manufactured by Hercules, Wilmington, Del.), a silane-surface-modified silica gel dispersion, Sylojet 703C (manufactured by W. R. Grace & Co., Columbia, Md.), and a ethylene-vinyl acetate latex binder, Airflex TL-51 (manufactured by Air Products and Chemicals, Inc., Allentown, Pa.), a silicone softener, Dousoft OH (manufactured by Boehme Filatex, Reidsville, N.C.), and a fluorescent whitening agent, Ultraphor SFN (manufactured by BASF, Charlotte, N.C.) was made according to the following formula in parts by weight:

| | |
|---|---|
| Water | 53 parts |
| Kymene 736 | 30 parts |
| Airflex TL-51 | 10 parts |
| Sylojet 703C | 5 parts |
| Dousoft OH | 1.5 parts |
| Ultraphor SFN | 0.5 parts |

A woven cotton fabric (cotton Poplin) substrate was impregnated with the above solution, passing through nip rolls to get a wet pickup of about eighty percent (80%). The impregnated substrate was dried in a convection oven at 300° F. for five (5) minutes. The treated substrate was printed and tested for washfastness as described below, and the results are shown in Table 6.

The treated substrate was printed with solid squares of 4 primary colors (red, blue, yellow and black) using a Hewlett Packard DeskJet 932C ink jet printer. The treated substrate showed very good sharpness at the edges with excellent color holdout and no evidence of ink feathering. The washing procedure was the same as used in Examples 1-3, including the drying. This washing process was repeated up to values of five (5) and fifteen (15) times. Color value (CIE L*, a* and b* values) of each primary color on the printed fabrics after one wash was measured using X-Rite SP78 Spectrophotometer utilizing the QA Master software for Microsoft Windows Version 1.71 (both manufactured by X-Rite Inc., Grandville, Mich.). Delta E (cmc) versus the color printed on a piece of white paper (Hammermill Inkjet 24 lb. paper manufactured by International Paper of Memphis, Tenn.) was used to measure the color loss reported in Table 6.

TABLE 6
Washfastness

| | | ΔE CMC vs. Hammermill | | | |
|---|---|---|---|---|---|
| | | Jet Print 24# Paper | | | |
| Example | Washes | Black | Yellow | Red | Blue |
| Example 12 | 5 | 1.54 | 6.14 | 3.78 | 4.23 |
| | 15 | 4.04 | 8.11 | 6.36 | 6.44 |
| Example 13 | 5 | 1.51 | 2.14 | 2.47 | 2.23 |
| | 15 | 1.67 | 5.00 | 5.68 | 5.07 |

Example 12 was used to test several ink jet dyes by making about a 5% solution in mixture of water and propylene glycol and a solid color circle was inkjet printed using each dye on an unprinted fabric of Example #15 using a thermal inkjet printing head. Waterfastness of the print was tested by soaking the printed circle in small amount of water for 5 days and observe the color bleeding into water and color migration to outside the color circle, and the results are shown below in Table 7.

TABLE 7
Ink Bleed And Migration

| | Anionic | | | |
|---|---|---|---|---|
| | Group on | Net | | |
| | The | Negative | Bleed into | Color |
| Dye Molecules | Chromophore | Charge | Water | Migration |
| C.I. Acid red 1 | 2 SO₃¹⁻ | 2 | Minimal | No Migration |
| C.I. Acid | One —O⁺−, | 1 | Significant | Severe |
| red 52 | 2 SO₃¹⁻ | | | |
| C.I. Acid | One —O⁺−, | 1 | Significant | Moderate |
| red 289 | 2 SO₃¹⁻ | | | |
| C.I. Direct | 6 SO₃¹⁻ | 6 | Minimal | No Migration |
| Red 227 | | | | |
| Pro-jet fast | | | None | No Migration |
| Magenta 2 | | | Noticeable | |
| C.I. Acid | 2 SO₃^{1-,} | 3 | None | No Migration |
| yellow 23 | One COO⁻¹ | | Noticeable | |
| C.I. Acid | One ═N⁺ , | 2 | Slight | Slight |
| blue 9 | 3 SO₃¹⁻ | | | |
| C.I. Direct | 2 SO₃¹⁻ | 2 | Minimal | No Migration |
| blue 86 | | | | |

As can be seen in Table 7, dye molecules with more than 2 net negative charges on the chromophor of the molecule give satisfactory water fastness on this inventive highly cationic treated fabric. Dye molecules with carboxylic acid moiety, such as Pro-Jet Fast Red and C.I. Acid yellow 23, have superior water fastness.

### EXAMPLE 13

A treatment mixture was formed of the same components as in Example 12 in the following formula in parts by weight:

| | |
|---|---|
| Water | 33 parts |
| Kymene 736 | 30 parts |
| Airflex TL-51 | 10 parts |
| Sylojet 703C | 25 parts |
| Dousoft OH | 1.5 parts |
| Ultraphor SFN | 0.5 parts |

The above treatment was aplaced on the same woven cotton Poplin fabric substrate as Example 12, in the same manner as Example 12. The washfastness of Example 13 was tested in the same manner as prescribed in Example 12, and the results are reported in Table 6. Suprisingly, as shown in Table 6, increasing the amount of surface-modified inorganic particles of the treatment increases the wastfastness of the treated substrate.

### EXAMPLES 14-17

Varying levels of a lubricant (Duosoft OH) were added to the treatment formula used in Example 13, and impregnated onto the same substrate as Example 13 in the same manner to form Examples 14-17. The amount of lubricant added to the treatment formula for each example as specified in Table 8. A test was then performed to determine the amount of force needed to pass a sewing needle through the treated substrates. To determine the force necessary to pass the needle through the treated substrates, a quilting/between hand sewing needle size 10 was mounted facing upward to a AccuForce III force meter manufactured by AMETEK of Largo, Fla. Samples of the treated substrates of Examples 14-17 were folded over itself (2-ply) and mounted in an embroidery frame. The folded and treated substrates were then pressed down onto the mounted needle, and the maximum force of compression to pass the needle through both layers of substrate was recorded as a measure of the ease/difficulty of passing a needle through the fabric and averaged over several trials. The larger the force recorded, the more difficult it is to pass a needle through the fabric. The values for each Example were recorded and are listed in Table 8.

TABLE 8
Lubricant Levels and Needle Force

| Example | Lubricant Level (%) | Needle Force (kg) |
|---|---|---|
| Example 13 | 0 | 1.3 |
| Example 14 | 1.0 | 0.8 |
| Example 15 | 2.0 | 0.7 |
| Example 16 | 3.0 | 0.6 |
| Example 17 | 5.0 | 0.5 |

As shown in Table 8, addition of a compatible softener can reduce the needle force required to pass a needle through the treated substrate.

### EXAMPLES 18-21

A woven Poplin cotton fabric was treated with a treatment mixture containing various amounts of a reactive dye fixing agent, Kymene 736 (manufactured by Hercules, Wilmington, Del.), a silane-surface-modified silica gel dispersion, Sylojet 703C (manufactured by W. R. Grace & Co., Columbia, Md.), and a ethylene-vinyl acetate latex binder, Airflex TL-51(manufactured by Air Products and Chemicals, Inc., Allentown, Pa.), a silicone softener, Dousoft OH (manufactured by Boehme Filatex, Reidsville, N.C.), a fluorescent whitening agent, Ultraphor SFN (manufactured by BASF, Charlotte, N.C.), and sufficient 50% caustic (sodium hydroxide) to adjust th3 pH of the mixture to about 7, as specified below in Table 9.

TABLE 9
Treatment Mixture (Parts by Weight)

| Component | Example 18 | Example 19 | Example 20 | Example 21 |
|---|---|---|---|---|
| Water | 23.2 | 33.4 | 43.6 | 53.8 |
| 50% Caustic | 0.8 | 0.6 | 0.4 | 0.2 |
| Kymene 736 | 40 | 30 | 20 | 10 |
| Airflex TL-51 | 7 | 7 | 7 | 7 |
| Sylojet 703C | 25 | 25 | 25 | 25 |
| Dousoft OH | 3 | 3 | 3 | 3 |
| Ultraphor SFN | 1 | 1 | 1 | 1 |

The woven poplin cotton fabrics for Examples 18-21 were impregnated with the corresponding treatment above, passing through nip rolls to get a wet pickup of about 80%. The impregnated fabrics were dried in a convection oven at 300° F. for about 5 minutes.

Samples of each of the Examples were printed with solid squares of 4 primary colors (red, blue, yellow and black) using a Hewlett Packard DeskJet 932C ink jet printer. The printed substrates were then washed in a regular home washer using delicate cycle using Gentle Cycle Woolite neutral detergent following AATCC Standardization of Home Laundry Text Condition (Developed in 1984 by AATCC Committee RA88, and as revised in 1986, 1992, and 1995.). These fabrics were then dried in a regular home dryer at low heat for 20 minutes. This washing process was performed on the treated and printed fabrics for a total of one (1), five (5) and ten (10) times. Color value (CIE L*, a* and b* values) of each primary color on the printed fabrics was measured using an X-Rite SP78 Spectrophotometer utilizing QA Master software for Microsoft Windows Version 1.71 (both manufactured by X-Rite Inc., Grandville, Mich.) before any washing, and after each washing. Delta E (cmc) versus the color printed on a piece of white paper (Hammermill Inkjet 24 lb. paper manufactured by International Paper of Memphis, Tenn.) was used to measure the color loss, summarized below in Table 10.

Non-printed samples of each of the Examples 18-21 were tested for charge density as explained below, at zero (0) washes, one (1) washing, five (5) washings, and ten (10) washings, as described above. The data obtained from these measurements is summarized below in Table 10.

To determine the charge density of a substrate, a sample of the substrate is placed in a master solution containing dye molecules of a known charge, the light absorbency of the master solution is measured before and after immersion, the difference in absorbency is used to calculate the amount of dye molecules left on the sample, and the amount of dye molecules left on the sample and the area of the sample are used to calculate the charge density of the substrate before immersion. Two inch (2″) by two inch (2″) samples of the textile substrate were immersed into a twenty five (25) gram master solution for ten (10) minutes. The master solution was formed using 121.5 mg of cresol red (CAS#1733-12-6) dye (404.2 g/mol. by Aldrich) into 431.0 g de-ionized water to make a 0.0282% solution by weight. Samples of the untreated substrate with no washings, and treated substrates with no (0) washes, one (1) washing, and five (5) washings, were each placed in its own master solution. The light absorbency of the master solution for each sample was measured at 434 nm in the UV-Visible spectrum before and after immersion of the sample.

The change in light absorbency of the master solution for each sample can be used to determine the amount of dye left on the sample. To determine the amount of dye left on the sample from the master solution, a plot of dye concentration verses light absorbency must be calculated from known dye concentration standards. The dye concentration standards can be created by diluting the master solution. Ten dye concentration standards were created by diluting the master solution, forming ten dye concentration standards with known dye concentrations (w/w) ranging between 5×10⁻⁶ to 4×10⁻⁵. The light absorbency of each dye concentration standard was measured at 434 nm in the UV-Visible spectrum, and the concentration and light absorbency data were fitted into Beer's law to form the plot of dye concentration verses light absorbency.

For each of the samples, the difference in light absorbency of the master solution before and after the immersion of the samples is used to determine from the dye concentration verses light absorbency plot the amount of dye left on the sample. Since cresol red dye has only one negative charge per molecule, the amount of cationic charge on the substrate can be calculated based on the number of dye molecules absorbed over the unit area of the substrate. The charge density of the substrate is then reported in millimole/m² or milliequivalent/m².

TABLE 10
Washfastness

| | | Delta E cmc | | | | Charge Density |
|---|---|---|---|---|---|---|
| Test Sample | Washings | Black | Yellow | Red | Blue | (meq/m²) |
| Example 18 | 0 | 5.31 | 4.71 | 2.15 | 1.69 | 6.59 |
| | 1 | 4.28 | 5.32 | 1.97 | 3.20 | 6.48 |
| | 5 | 3.22 | 6.57 | 3.93 | 2.79 | 2.42 |
| | 10 | 2.92 | 7.57 | 6.75 | 4.40 | 0.39 |
| Example 19 | 0 | 4.52 | 4.48 | 2.05 | 1.65 | 5.96 |
| | 1 | 3.92 | 5.64 | 1.68 | 3.06 | 5.44 |
| | 5 | 3.28 | 6.72 | 4.21 | 6.09 | 0.52 |
| | 10 | 3.12 | 10.36 | 7.94 | 7.57 | 0.00 |
| Example 20 | 0 | 3.81 | 4.17 | 1.53 | 1.70 | 6.08 |
| | 1 | 3.20 | 5.61 | 2.21 | 2.97 | 4.09 |
| | 5 | 2.70 | 7.28 | 6.25 | 4.03 | 0.00 |
| | 10 | 2.22 | 9.44 | 6.76 | 5.99 | 0.00 |
| Example 21 | 0 | 2.56 | 5.43 | 2.38 | 3.41 | 1.73 |
| | 1 | 1.83 | 6.31 | 2.75 | 5.16 | 0.18 |
| | 5 | 2.13 | 13.82 | 8.15 | 8.28 | 0.00 |
| | 10 | 3.90 | 14.14 | 12.46 | 10.69 | 0.00 |

### EXAMPLES 21-22

A woven cotton Poplin fabric and a polyester Poplin woven fabric treated with the following formula:

| | |
|---|---|
| Kymene 736 | 20 parts |
| Sylojet 703 | 25 parts |
| Airflex Tl-51 | 10 parts |
| water | 45 parts |

A photo-image and a set of black, red, blue and yellow color blocks were printed on each fabric using Epson Stylus Photo 2000P printer with aqueous pigment ink.

Printed fabrics were washed once in a home washing machine with added liquid detergent. There was virtually no visible color loss after 1 wash. In comparison, an untreated polyester fabric printed with the same pattern using the same printer, showed dramatic visible color loss after one home wash.

For outdoor weather durability, the printed fabrics were tested in an accelerated weather-o-meter using SAE J1960 method where fabric samples were exposed to high intensity of UV radiation, and intermitted water spray for 21 days. The amount of exposure in the weather-o-meter is equivalent to 3 month Florida outdoor life. The color changes in terms of ΔE_{CMC} before and after weather-o-meter exposure were measured and summarized below in Table 11. As can be seen from the results in the table, there was little color change on both printed fabrics. There were no chalking or any other obvious degradation on those printed fabric at the end of 21 day exposure.

TABLE 11
Color Change, ΔE_{CMC} After Weather-O-Meter Exposure

| | Color block | | | |
|---|---|---|---|---|
| | Black | Yellow | Red | Blue |
| Example 21 (Treated polyester fabric) | 4.06 | 0.99 | 0.82 | 4.26 |
| Example 22 (Treated Cotton fabric) | 3.57 | 0.55 | 0.29 | 6.52 |

The same treated fabrics were also printed with Mimaki JV-4 wide format printer using aqueous pigment ink without resin binder. The resulted prints have the same water fast, wash fast and weather durable properties.

### EXAMPLES 23-25

A 100% cotton poplin fabric was prepared and were impregnated with the mixtures as illustrated below in Table 12, at about a 80% by weight wet pick-up:

TABLE 12
Treatment Mixtures In Parts By Weight

| | Example | Example | Example |
|---|---|---|---|
| Component | 23 | 24 | 25 |
| Water | 80 | 80 | 60 |
| Kymene 736 | 20 | 0 | 20 |
| (Reactive Amino Compound) | | | |
| Sylojet 703C | 0 | 20 | 20 |
| (Cationic Inorganic | | | |
| Particle Dispersion) | | | |

All impregnated fabrics were dried and cured in a 300 F convection oven for 5 minutes.

The above treated fabric pieces were printed with Hewlett Packard 932C color ink jet printer. Four squares of primary colors (red, blue, yellow and black) and a test image were printed on each fabric samples. Color measurement using a Hunter colorimeter were made on each color square to determine the saturation level of each color (CIE Lab. L, a, and b values were recorded). Visual inspection on the test color image is also used to determine the color brightness and print sharpness. The same pieces of printed fabrics were then washed one time in a regular home washing machine according to the AATCC Standardization of Home Laundry Text Cond., using regular cycle with warm water and dried. Color measurement and visual inspection were again conducted on the washed fabric prints after washing. The measurements were reported in Tables 13-16 below for each of the primary colors (Red, Black, Blue, and Yellow). A visual inspection of the color image printed on Examples 23-25 also indicates that Example 25 gives the brightest and sharp print before and after wash.

TABLE 13
Printed Red Square

| Example | Washes | L | a | b |
|---|---|---|---|---|
| Example 23 | 0 | 46.21 | 37.62 | 21.14 |
| | 1 | 61.05 | 24.02 | 15.98 |
| Example 24 | 0 | 47.15 | 36.45 | 23.07 |
| | 1 | 88.85 | 7.14 | −1.84 |
| Example 25 | 0 | 45.16 | 41.7 | 24.19 |
| | 1 | 56.37 | 31.57 | 19.80 |

As seen above in Table 13, Example 25 (with the combination of both a reactive amino compound and inorganic particles) showed higher color a value and lower L value before and after wash of the Example in that table, indicating that Example 25 has a deeper red print before and after wash. In the case of Example 24 after wash, very little color was left on the fabric after washing as indicated by the high reflectance “L” value and dramatic change in “a” and “b” values after wash. There was-no visual difference observed between a print on an untreated cotton fabric and a print on Example 24 treated fabric after wash.

TABLE 14
Printed Black Square

| Example | Washes | L | a | b |
|---|---|---|---|---|
| Example 23 | 0 | 22.64 | 0.65 | 2.13 |
| | 1 | 27.75 | 0.57 | 1.69 |
| Example 24 | 0 | 28.76 | 0.83 | 2.88 |
| | 1 | 36.17 | 0.87 | 2.52 |
| Example 25 | 0 | 21.26 | 0.6 | 2.08 |
| | 1 | 25.5 | 0.59 | 1.52 |

As seen in Table 14, Example 25 has the lowest reflectance L value of the Examples in that table, indicating that it has the darkest black color before and after wash.

TABLE 15
Printed Blue Square

| Example | Washes | L | a | b |
|---|---|---|---|---|
| Example 23 | 0 | 41.88 | −0.74 | −33.58 |
| | 1 | 53.16 | −7.02 | −27.91 |
| Example 24 | 0 | 41.20 | −0.87 | −35.25 |
| | 1 | 84.51 | −6.15 | −15.71 |
| Example 25 | 0 | 40.04 | −0.66 | −36.02 |
| | 1 | 48.03 | −5.40 | −33.05 |

As seen in above Table 15, with Example 25 showed a lower “b” value and lower “L” value before and after wash. This indicates a deeper blue print before and after wash. In the case of Example 24 after wash, very little color is left on the fabric as indicated by the high reflectance “L” value and dramatic change in “a” and “b” values after wash. There was no visual difference observed between a print on an untreated cotton fabric and print on Example 24 treated fabric after wash.

TABLE 16
Printed Yellow Square

| Example | Washes | L | a | b |
|---|---|---|---|---|
| Example 23 | 0 | 75.37 | 1.15 | 60.65 |
| | 1 | 78.27 | −3.58 | 37.75 |
| Example 24 | 0 | 76.38 | −0.23 | 66.85 |
| | 1 | 93.30 | −0.95 | 1.47 |
| Example 25 | 0 | 75.97 | 1.18 | 66.65 |
| | 1 | 77.59 | −2.22 | 50.02 |

As seen in above Table 16, Example 25 (with the combination of a reactive amino compound with inorganic particles) showed higher “b” value and lower “L” value before and after wash. This indicates a deeper yellow print before and after wash. In the case of Example 24 after wash, very little color is left on the fabric as indicated by the high reflectance “L” value and dramatic change in “a” and “b” values after wash. There was no visual difference observed between a print on an untreated cotton fabric and a print on Example 24 treated fabric after wash.

What is claimed is:

1. A textile comprising:
a textile printing substrate including:
a textile substrate having a first side and a second side;
a dye fixing/receiving composition disposed on the first side of the textile substrate, the dye fixing/receiving composition including:
an amino compound forming a chemical bond with the textile substrate; and
inorganic particles;
an anionic dye disposed on the dye fixing/receiving composition of the textile substrate, the anionic dye including raticals from the carboxylic acid group.

2. The textile according to claim 1, wherein the dye fixing/receiving agent further includes a resin binder.

3. A method of providing a textile with an colorant thereon, the method comprising the steps of:
providing a textile substrate having a first side
providing a dye fixing/receiving agent including a reactive amino compound and inorganic particles;
placing the dye fixing/receiving agent on the first side of the textile substrate such that a chemical bond is formed between the amino compound and the textile substrate;
providing an anionic dye having at least two net anionic charge on the chromophore moiety on each molecule;
placing the anionic dye onto the first surface of the textile substrate having the dye fixing/receiving agent thereon.

4. The method according to claim 3, wherein the step of providing the dye fixing/receiving agent further includes the dye fixing/receiving agent including at least one of the anionic charges being provided by a moiety from the carboxylic acid group.

5. The method according to claim 3, wherein the step of providing the dye fixing/receiving agent further includes the dye fixing/receiving agent including a resin binder.

6. The method according to claim 5, wherein the step of providing the dye fixing/receiving agent further includes the dye fixing/receiving agent including at least one of the anionic charges being provided by a ratical from the carboxylic acid group.

6. A textile comprising:
a textile printing substrate including:
a textile substrate having a first side and a second side;
a dye fixing/receiving composition disposed on the first side of the textile substrate, the dye fixing/receiving composition including an amino compound; and
a pigment ink disposed on the dye fixing/receiving composition of the textile substrate, said pigment ink containing a pigment to binder ration of about 10 to 1, or greater, by weight.

7. A textile comprising:
a textile printing substrate including:
a textile substrate having a first side and a second side;
a dye fixing/receiving composition disposed on the first side of the textile substrate, the dye fixing/receiving composition including:
a resin binder;
an amino compound; and
inorganic particles;
a pigment ink disposed on the dye fixing/receiving composition of the textile substrate, said pigment ink having a pigment to binder ration of about 10 to 1, or greater, by weight.

8. A method of providing a textile with an colorant thereon, the method comprising the steps of:
providing a textile substrate having a first side
providing a dye fixing/receiving agent including an amino compound;
placing the dye fixing/receiving agent on the first side of the textile substrate;
providing an aqueous pigment ink having a pigment to binder ration of about 10 to 1, or greater, by weight;
placing the aqueous pigment ink onto the first surface of the textile substrate having the dye fixing/receiving agent thereon.

9. The method according to claim 8, wherein the step of providing the dye fixing/receiving agent further includes the dye fixing/receiving agent including a resin binder.

10. The method according to claim 8, wherein the step of placing the aqueous pigment ink onto the first surface of the textile substrate includes placing the aqueous pigment ink onto the first surface with an ink jet printer.

11. The method according to claim 8, wherein the step of placing the aqueous pigment ink onto the first surface with an ink jet printer includes the use of a thermal ink jet printing process.

12. The method according to claim 8, wherein the step of placing the aqueous pigment ink onto the first surface with an ink jet printer includes the use of a piezo ink jet printing process.
